(19) United States
(12) Patent Application Publication
(10) Pub. No.: US 2008/0050638 A1
(43) Pub. Date: Feb. 28, 2008

(54) Bipolar plate and fuel cell having stack of bipolar plates

(75) Inventors: Jie Peng, Yongin-si (KR); Seung-jae Lee, Yongin-si (KR); Tae-won Song, Yongin-si (KR); Jae-young Shin, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co, Ltd., Suwon-si (KR)

(21) Appl. No.: 11/701,444

(22) Filed: Feb. 2, 2007

(30) Foreign Application Priority Data
Aug. 22, 2006 (KR) 2006-79472

(51) Int. Cl. H01M 8/24; H01M 8/04

(52) U.S. Cl. 429/35

(57) ABSTRACT

A structure of a bipolar plate for a fuel cell to ensure continuous flow of fluids to flow channels. The bipolar plate includes a plate main body having a surface and an opposite surface, each surface having reaction flow channels through which fluids pass; manifolds formed on the plate main body in the form of an inlet for introducing to and an outlet for discharging a fluid from the reaction flow channel, and connection channels that are formed on the plate main body as connection units between the reaction flow channels and the manifold, wherein the connection channels are formed such that flat regions of both a surface and an opposite surface of the plate main body face each other when the plate main bodies are stacked. The gasket is attached to the flat surface of the plate main body.

### CROSS-REFERENCE TO RELATED APPLICATIONS

This application claims the benefit of Korean Patent Application No. 2006-79472, filed on Aug. 22, 2006, in the Korean Intellectual Property Office, the disclosure of which is incorporated herein in its entirety by reference.

### BACKGROUND OF THE INVENTION

1. Field of the Invention

Aspects of the present invention relate to a bipolar plate used for a fuel cell, and more particularly, to a bipolar plate having a structure that ensures continuous flow of fluids through flow channels and a fuel cell having a stack in which a plurality of the bipolar plates are stacked.

2. Description of the Related Art

A fuel cell is an electricity generator that changes chemical energy of a fuel into electrical energy through a chemical reaction, and the fuel cell can continuously generate electricity as long as the fuel is supplied. FIG. 1 is a schematic drawing illustrating the energy transformation structure of a fuel cell. Referring to FIG. 1, when air, which includes oxygen, is supplied to a cathode 1 and a fuel containing hydrogen is supplied to an anode 3, electricity is generated by the recombination of water through an electrolyte membrane 2. The anode 3 catalytically splits hydrogen into positively charged hydrogen ions and negatively charged electrons. The electrolyte membrane 2 only allows the positively charged hydrogen ions to pass forcing the negatively charged electrons to flow through an external circuit thereby producing current. The positively charged hydrogen ions and the negatively charged electrons recombine with oxygen at the cathode 1 to form water. However, a unit cell does not generally produce a high enough voltage to be useful for a device. Therefore, electricity is generated from a plurality of unit cells connected in series in the form of a stack.

FIG. 2 is an exploded perspective view illustrating a structure of a conventional unit cell. Referring to FIG. 2, a unit cell of a stack has a structure in which a cathode 1, an anode 3, and an electrolyte membrane 2 are disposed between a pair of bipolar plates 10. An assembly in which the cathode 1, the anode 3, and the electrolyte membrane 2 are combined is referred to as a membrane and electrodes assembly (MEA) 20. Reaction flow channels 11 constituting flow paths through which oxygen and hydrogen are supplied to the cathode 1 and the anode 3 are formed in the bipolar plates 10. Therefore, hydrogen and oxygen supplied from outside the cell are supplied to the cathode 1 and the anode 3 through the reaction flow channels 11. A fuel cell stack is formed by repeating the structure of the unit cell.

Referring to FIG. 2, a gasket 30 seals the reaction flow channels 11 together with the MEA 20 and is disposed between the bipolar plates 10 to prevent hydrogen or oxygen from leaking from the cell. A fuel cell stack is formed by repeatedly stacking unit cells such that the MEA 20 of each unit cell is disposed at a central portion of the bipolar plates 10, and the gasket 30 is attached along the edges of the bipolar plates 10. Receiving spaces 12 formed on the bipolar plates 10 are connected to an inlet 10a and an outlet 10b of the bipolar plates 10 so that a fluid can enter and leave the reaction flow channels 11 and contact the cathode 1 and the anode 3 of the MEA 20. Accordingly, the fluid that enters one of the receiving spaces 12 through the inlet 10a generates a fuel cell reaction on the cathode 1 and the anode 3 while passing through the reaction flow channels 11, and then leaves the bipolar plates 10 through the outlet 10b via a receiving space 12 located on an opposite side of the bipolar plate 10.

A constant seal of the receiving spaces 12 is maintained by the gasket 30 inserted between the bipolar plates 10. However, since the gasket 30 is formed of a soft elastic material, there is a high possibility of the gasket 30 blocking the receiving spaces 12. That is, as schematically shown in FIG. 3A, the gasket 30 attached to the bipolar plates 10 must seal the bipolar plates 10 by attaching about the receiving spaces 12 so the fuel cell can perform properly with a continuous flow of the fluid through the receiving spaces 12. However, as schematically shown in FIG. 3B, the gasket 30, formed of a soft elastic material, blocks the receiving space 12 by attaching to a wall of the receiving space 12 resulting in interruption of the fluid flow to the MEA 20. In the past, the bipolar plates 10 had a thickness of approximately 1 cm, and accordingly, the depth of the receiving spaces 12 was deeper; thus, the receiving spaces were not easily blocked even when the gasket 30 became slightly loose. However, as recent bipolar plates 10 have decreased in thickness, blocking of the receiving spaces occurs more frequently. In particular, blocking of the receiving spaces 12 occurs when the gasket 30 formed of a soft elastic material is located between two of the receiving spaces 12 that are facing each other, as depicted in FIGS. 2, 3A, and 3B. When the electrolyte membrane 2 swells from absorbing moisture during the fuel cell reaction, the gasket 30 may not be tightly supported by the bipolar plates 10 and may be pushed into one of the receiving spaces 12. In such situations, the likelihood of the gasket 30 attaching to a wall of the receiving spaces 12 increases. Pressure differentials in the adjacent reaction flow channels 11 may also cause the gasket 30 to enter and contact the walls of the receiving spaces 12 and block flow of the fluids to the reaction flow channels 11. In these and other cases, the normal operation of the fuel cell is impossible since hydrogen or oxygen cannot be supplied to the cathode 1 and the anode 3, respectively, through the reaction flow channels 11.

In order to solve such problems, a structure, as depicted in FIG. 4, in which a metal bridge plate 40 covers an upper part of the receiving space 12 has been proposed. That is, to maintain air-tightness and to prevent blocking of the receiving spaces 12 by the gasket 30, even when multiple unit cells are stacked, the metal bridge plate 40 is disposed on a step difference unit 12a formed in the receiving space 12. The gasket 30 is attached to the metal bridge plate 40. However, in this structure, the flow of the fluid is restricted since the volume of the receiving spaces 12 is reduced by an amount proportional to the thickness of the metal bridge plate 40. Also, there are drawbacks in the increased number of parts, and the metal bridge plate 40 corrodes after a prolonged operation.

### SUMMARY OF THE INVENTION

Aspects of the present invention relate to a bipolar plate that ensures a continuous flow of fluid to and from the MEA and a fuel cell having a stack of unit fuel cells in which the bipolar plates are used.

According to an aspect of the present invention, there is provided a bipolar plate including: a plate main body having a surface and an opposite surface, each surface having reaction flow channels through which fluids pass; manifolds formed on the plate main body in the form of an inlet for introducing a fluid to the reaction flow channels and an outlet for discharging the fluid from the reaction flow channels; and connection channels that are formed on the plate main body to connect the reaction flow channels and the manifolds, wherein the connection channels are formed such that flat regions of both the surface and the opposite surface of the plate main body face each other when the plate main bodies are stacked, and the gaskets are attached to the flat surfaces of the plate main bodies.

According to an aspect of the present invention, there is provided a fuel cell having a stack in which assemblies of two electrodes and an electrolyte membrane and bipolar plates are stacked, wherein the bipolar plates comprise: a plate main body having a surface and an opposite surface, each surface having reaction flow channels through which fluids pass; manifolds formed on the plate main body in the form of an inlet for introducing a fluid to the reaction flow channel and an outlet for discharging the fluid from the reaction flow channel; and connection channels that are formed on the plate main body as connection units between the reaction flow channels and the manifold, wherein the connection channels are formed such that flat regions of both a surface and an opposite surface of the plate main body face each other when the plate main bodies are stacked, and the gasket is attached to the flat surface of the plate main body.

The connection channel may include a first channel, which is connected to a manifold on the surface of the plate main body and connected through the plate main body to the reaction flow channel formed on an opposite surface of the plate main body, and a second channel connected to a manifold on an opposite surface of the plate main body and connected through the plate main body to the reaction flow channel on the surface of the plate main body, wherein, when the plate main bodies are stacked, the first channels are aligned to be stacked on the first channels, and the second channels are aligned to be stacked on the second channels, but the first channels and the second channels of adjacent plate main bodies do not overlap each other.

The first channels and the second channels of adjacent plate main bodies may cross each other.

Flat surfaces may be formed on edge portions of the plate main bodies that face each other when the plate main bodies are stacked so that the gasket is attached to the edge portions of the plate main bodies together the flat surfaces formed by the connection channels.

The manifolds may have an L shape or an I shape through which fluids including hydrogen and oxygen can flow, and the manifold and the reaction flow channels are connected by the connection channel.

According to an aspect of the invention, a fuel cell is provided having a stack in which assemblies of two electrodes, an electrolyte membrane and bipolar plates are stacked, wherein the bipolar plates may include: a plate main body having a surface and an opposite surface, each surface having reaction flow channels through which fluids pass; manifolds formed on the plate main body in the form of an inlet for introducing a fluid to the reaction flow channels and an outlet for discharging the fluid from the reaction flow channels; and connection channels that are formed on the plate main body to connect the reaction flow channels and the manifolds, and to which gaskets for sealing the bipolar plates are attached when the bipolar plates are stacked, wherein the connection channels are formed such that flat regions of both the surface and the opposite surface of the plate main body face each other when the plate main bodies are stacked, and the gaskets are attached to the flat surfaces of the plate main bodies.

According to an aspect of the invention, the connection channels may include: a first channel, which is connected to a manifold on the surface of the plate main body and connected through the plate main body to the reaction flow channel formed on the opposite surface of the plate main body; and a second channel connected to a manifold on the opposite surface of the plate main body and connected through the plate main body to the reaction flow channel on the surface of the plate main body, wherein, when the plate main bodies are stacked, the first channels are aligned to be stacked on the first channels, and the second channels are aligned to be stacked on the second channels, but the first channels and the second channels of adjacent plate main bodies do not overlap each other.

According to an aspect of the invention, the first channels and the second channels of adjacent plate main bodies cross each other.

According to an aspect of the invention, the flat surfaces are formed on edge portions of the plate main bodies that face each other when the plate main bodies are stacked so that the gasket can be attached to the edge portions of the plate main bodies together with the flat surfaces formed by the connection channels.

According to another aspect of the invention, a bipolar plate is provided including: a plate main body having a first side and an opposite side; reaction flow channels on both the first side and the opposite side; manifolds to supply fluids to and remove fluids from the reaction flow channels; first connection channels to connect the manifolds to the reaction flow channels on the first side; and second connection channels to connect the manifolds to the reaction flow channels on the opposite side, wherein the first connection channels connect to the manifolds on the opposite side of the plate main body and extend therethrough to connect to the reaction flow channels on the first side of the plate main body, and the second connection channels connect to the manifolds on the first side of the plate main body and extend therethrough to connect to the reaction flow channels on the opposite side of the plate main body.

According to an aspect of the invention, the first connection channels form first flat surfaces on the first side of the plate main body, and the second connection channels form second flat surfaces on the opposite side of the plate main body, wherein the first and second flat surfaces allow for a gasket to circumscribe an area in which the reaction flow channels are formed, and the gasket does not separate two connection channels on adjacent stacked bipolar plates.

According to an aspect of the invention, the first connection channels align with the first connection channels of adjacent plate main bodies, and the second connection channels align with the second connection channels of adjacent plate main bodies when at least two bipolar plates are stacked.

According to an aspect of the invention, the first connection channels of adjacent plate main bodies do not overlap, and the second connection channels of adjacent plate main bodies do not overlap.

According to an aspect of the invention, the first connection channels of adjacent plate main bodies cross, and the second connection channels of adjacent plate main bodies cross.

According to another aspect of the invention, complementary bipolar plates are provided including: a first bipolar plate and a second bipolar plate, each may include: a plate main body having a first side and an opposite side; reaction flow channels on both the first side and the opposite side; manifolds to supply fluids to and remove fluids from the reaction flow channels; first connection channels to connect the manifolds to the reaction flow channels on the first side; and second connection channels to connect the manifolds to the reaction flow channels on the opposite side, wherein the first connection channels connect to the manifolds on the opposite side of the plate main body and extend therethrough to connect to the reaction flow channels on the first side of the plate main body, and the second connection channels connect to the manifolds on the first side of the plate main body and extend therethrough to connect to the reaction flow channels on the opposite side of the plate main body, wherein the first, the second, the third, and the fourth manifolds of each of the first bipolar plate and the second bipolar plate align, and the first connection channels of the first bipolar plate are in a first area of first and second manifolds and the first connection channels of the second bipolar plate are in a second area of the first and the second manifolds and, the second connection channels of the first bipolar plate are in a first area of third and fourth manifolds and the first connection channels of the second bipolar plate are in a second area of the third and the fourth manifolds.

According to an aspect of the invention, the first bipolar plate has a first flat surface that circumscribes an area in which the reaction flow channels of the first bipolar plate are formed, and the second bipolar plate has a second flat surface that circumscribes an area in which the reaction flow channels of the second bipolar plate are formed, wherein the first flat area and the second flat area correspond to each other.

According to another aspect of the invention, a fuel cell stack is provided, including: a plurality of membrane and electrode assemblies; a plurality of bipolar plates may be including: a plate main body having a first side and an opposite side; reaction flow channels on both the first side and the opposite side; manifolds to supply fluids to and remove fluids from the reaction flow channels; first connection channels to connect the manifolds to the reaction flow channels on the first side; and second connection channels to connect the manifolds to the reaction flow channels on the opposite side, wherein the first connection channels connect to the manifolds on the opposite side of the plate main body and extend therethrough to connect to the reaction flow channels on the first side of the plate main body, and the second connection channels connect to the manifolds on the first side of the plate main body and extend therethrough to connect to the reaction flow channels on the opposite side of the plate main body wherein the plurality of membrane and electrode assemblies are alternately stacked with the plurality of bipolar plates.

According to an aspect of the invention, the fuel cell stack further includes a gasket that seals the alternating membrane and electrode assemblies and bipolar plates and that circumscribes an area in which the reaction flow channels are formed, and the gasket does not separate the first or the second connection channels of the first bipolar plate from the first or the second connection channels of the adjacent bipolar plates.

According to an aspect of the invention, the bipolar plates are stacked so that the first and second connection channels do not face each other.

According to another aspect of the invention, a fuel cell stack is providing including: alternately stacked first bipolar plates and second bipolar plates, each first and second bipolar plate including: a plate main body having a first side and an opposite side; reaction flow channels on both the first side and the opposite side; manifolds to supply fluids to and remove fluids from the reaction flow channels; first connection channels to connect the manifolds to the reaction flow channels on the first side; and second connection channels to connect the manifolds to the reaction flow channels on the opposite side, wherein the first connection channels connect to the manifolds on the opposite side of the plate main body and extend therethrough to connect to the reaction flow channels on the first side of the plate main body, and the second connection channels connect to the manifolds on the first side of the plate main body and extend therethrough to connect to the reaction flow channels on the opposite side of the plate main body, wherein the first, the second, the third, and the fourth manifolds of each of the first bipolar plate and the second bipolar plate align, and the first connection channels of the first bipolar plate are in a first area of first and second manifolds and the first connection channels of the second bipolar plate are in a second area of the first and the second manifolds and, the second connection channels of the first bipolar plate are in a first area of third and fourth manifolds and the first connection channels of the second bipolar plate are in a second area of the third and the fourth manifolds, and a plurality of membrane and electrode assemblies disposed between the alternately stacked first and second bipolar plates.

According to an aspect of the invention, the fuel cell stack further including a gasket that seals the alternating membrane and electrode assemblies and complementary bipolar plates and that circumscribes an area in which the reaction flow channels are formed, and the gasket does not separate the first or the second connection channels of one complementary bipolar plate from the first or the second connection channels of the adjacent complementary bipolar plates.

Additional aspects and/or advantages of the invention will be set forth in part in the description which follows and, in part, will be obvious from the description, or may be learned by practice of the invention.

### BRIEF DESCRIPTION OF THE DRAWINGS

FIG. 1 is a schematic drawing illustrating the principle of electricity generation of a conventional fuel cell;

FIG. 2 is an exploded perspective view illustrating a structure of a unit cell having conventional bipolar plates;

FIGS. 3A and 3B are cross-sectional views for explaining the blocking of receiving spaces by a gasket of the bipolar plates of FIG. 2;

FIG. 4 is an exploded perspective view illustrating another conventional bipolar plate;

FIG. 5 is a perspective view illustrating a bipolar plate according to an embodiment of the present invention;

FIG. 6 is an exploded perspective view illustrating a structure of a unit cell having complementary bipolar plates according to an embodiment of the present invention;

FIG. 7A is a cross-sectional view taken along a line A-A of FIG. 5;

FIG. 7B is a cross-sectional view taken along a line B-B of FIG. 5; and

FIG. 8 is an exploded perspective view illustrating a state of fluid flow through the stacked complementary bipolar plates according to an embodiment of the present invention.

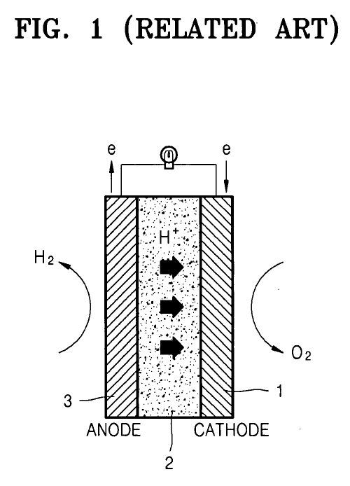

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below in order to explain aspects of the present invention by referring to the figures.

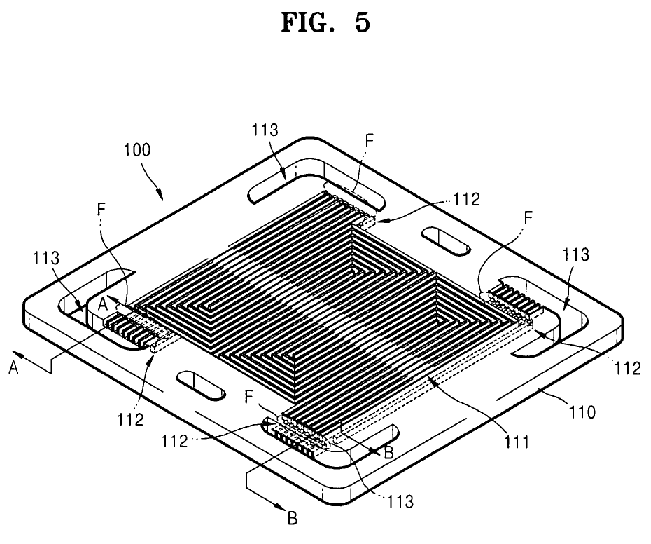

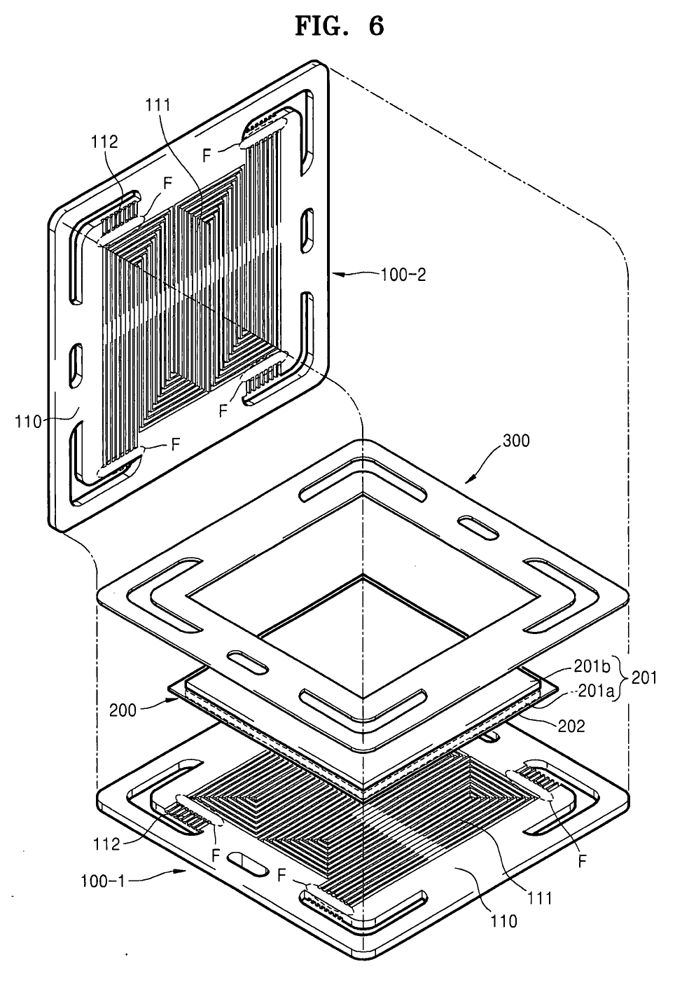

FIG. 5 is a perspective view illustrating a bipolar plate 100 according to an embodiment of the present invention. FIG. 6 is an exploded perspective view illustrating a structure of a unit cell having complementary bipolar plates 100-1 and 100-2 according to another embodiment of the present invention. A fuel stack can be formed by stacking the unit cells, as depicted in FIG. 6, by sealing the complementary bipolar plates 100-1 and 100-2 using a gasket 300 after inserting a membrane and electrode assembly (MEA) 200 between the bipolar plates 100-1 and 100-2.

Referring to FIG. 5, the structure of the bipolar plates 100 will now be described. Reaction flow channels 111 are formed on a first side and an opposite side of the bipolar plate 100 and supply hydrogen and oxygen to electrodes 201 (not shown) arranged on both surfaces of a MEA 200 (not shown). Manifolds 113, having an L shape, are formed near corners of the plate main body 110, and hydrogen and oxygen enter and leave through the manifolds 113. The manifolds 113 and the reaction flow channels 111 are connected by connection channels 112. The formation of the connection channels 112 results in a flat area F such that the gasket may be continuously attached to the outer surface of the plate main body 110 without extending between two open spaces that face each other. The shape of the manifolds 113 is not limited to an L shape, but may include any shape such as an I shape.

With reference to FIG. 6, when the unit cell is assembled, the electrodes 201 of the MEA 200 are located in a region of the bipolar plates 100 where gases flow through reaction flow channels 111. The gasket 300, which is for sealing the bipolar plates 100, is fixed on the plate main body 110 together with the MEA 200. The electrodes 201 include an anode 201a and a cathode 201b, and the locations of the anode 201a and the cathode 201b may be reversed depending on the design of the unit cell. The gasket 300 is attached to edge portions of the plate main body 110 meaning that the gasket 300 is attached to outer regions of the manifolds 113 and to flat surfaces F—the regions formed in the plate main body 110 by the connection channels 112 (not shown).

When the plate main bodies 110 are stacked, the attachment of the gasket 300 to the edge portions of the plate main body 110 results in the reaction flow channels 111 and the connection channels 112 not being blocked by the gasket as the entire area of the plate main body 110 to which the gasket attaches is flat.

Furthermore, FIG. 6 illustrates the stacking of a first pattern bipolar plate 100-1 and a second pattern bipolar plate 100-2. The first pattern bipolar plate 100-1 and the second pattern bipolar plate 100-2 are complementary and alternately stacked about the MEA 200 so that the connection channels 112 in each plate do not align with the connection channels 112 of the adjacent first pattern or second pattern bipolar plates 100-1 and 100-2, respectively.

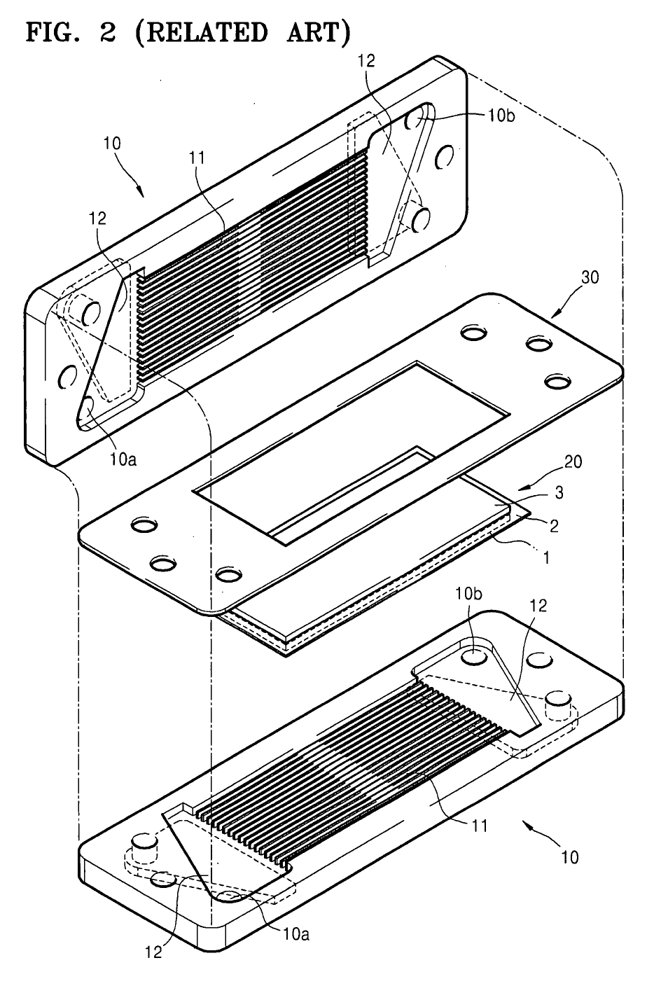

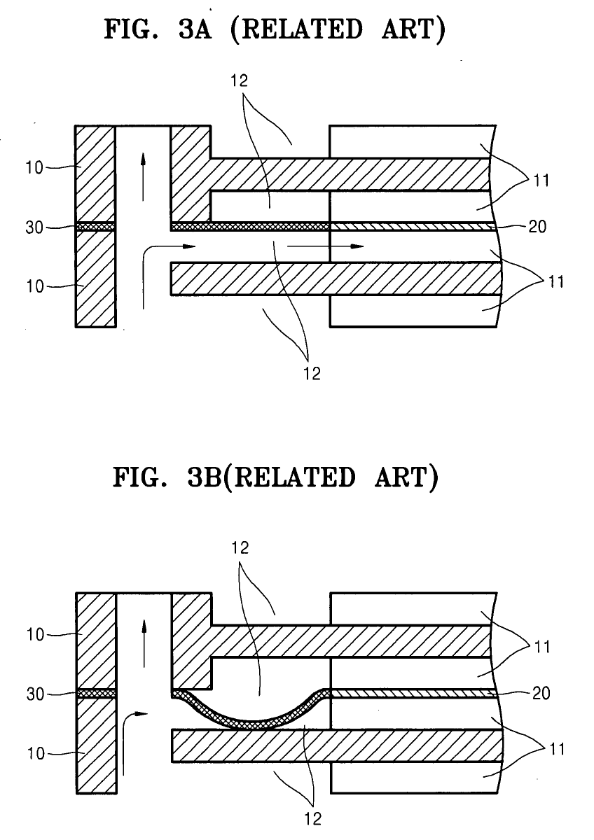

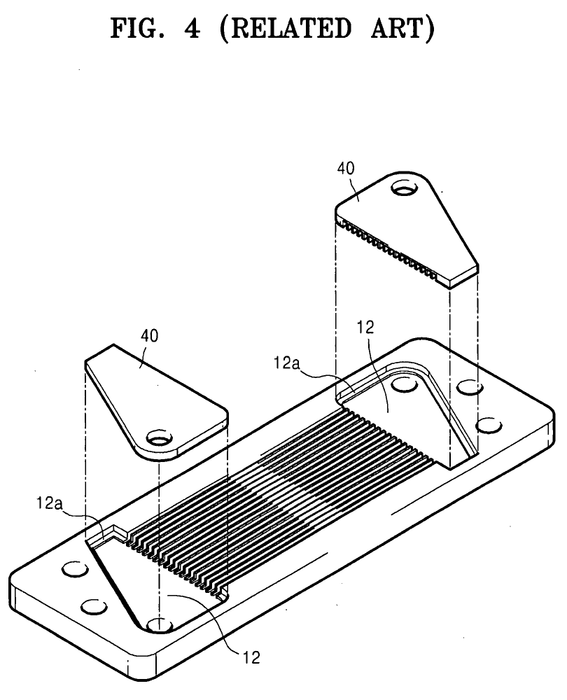

Instead of stacking bipolar plates 100 having the same shape, as depicted in FIG. 5, it is desirable to alternately stack a first pattern bipolar plate 100-1 and a second pattern bipolar plate 100-2 so that the connection channels 112 in each layer cross each other. If bipolar plates 100 having the same internal pattern are stacked, although empty spaces are not directly separated by the gasket 300 like in the conventional receiving spaces 12 (FIGS. 2, 3A, and 3B), the bipolar plates 100 are stacked having the connection channels 112 facing each other If the bipolar plates 100 are misaligned, portions of the connection channels 112 that face each other would be separated by only the gasket 300, resulting in a configuration similar to that of the related art and the possibility that the gasket 300 could block flow to the reaction flow channels 111. Accordingly, such alignment problems of the connection channels 112 can be avoided if the connection channels 112 are formed to cross each other by alternately stacking the two patterns of bipolar plates 100-1 and 100-2. Or, the alignment problems may be avoided by rotating the bipolar plates 100, or the complementary bipolar plates 100-1 and 100-2 before placing the plates into a fuel cell stack.

As such, the first pattern bipolar plate 100-1 and the second pattern bipolar plate 100-2 have similar but different patterns. The first pattern bipolar plate 100-1 and the second pattern bipolar plate 100-2 exhibit the same basic structure as described but the two patterns of the bipolar plates 100-1 and 100-2 cross each other meaning that, when stacked, the reaction flow channels 111 of the two patterns of the bipolar plates 100-1 and 100-2 generally do not run parallel to each other. Also, when the bipolar plates 100-1 and 100-2 are stacked, the connection channels 112 are arranged to connect to the manifolds 113 in different locations and generally cross each other. The first pattern bipolar plate 100-1 and the second pattern bipolar plate 100-2 may be mirror images and/or rotated when placed in a fuel cell stack.

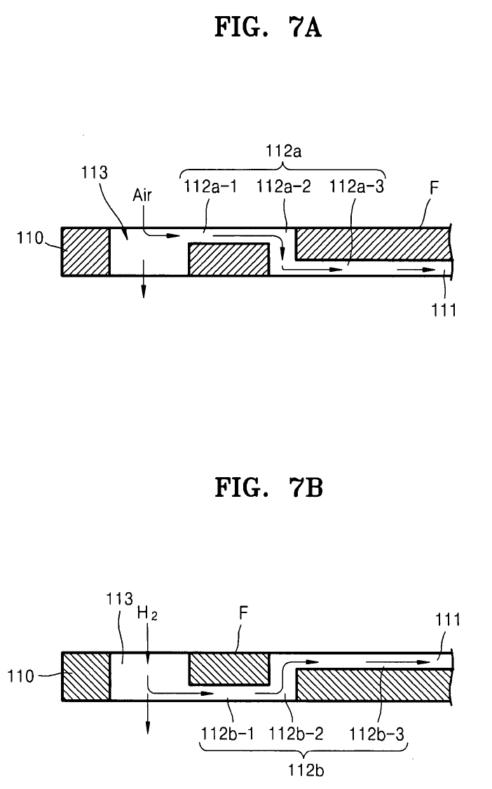

Referring to FIGS. 7A and 7B, it is considered that the connection channels 112 correspond to the conventional receiving spaces 12 (refer to FIG. 2). The connection channels 112 are formed to be consecutively connected from a first side to the opposite side, as defined by the direction of fluid flow, of the plate main body 110 instead of only flowing into and on one side of the plate main body 110. More specifically, the connection channels 112 can be divided into a first type channel 112a and a second type channel 112b. The first type channels 112a are flow channels through which air passes. The air is provided as the source of oxygen for the MEA 200. The first type channels 112a have a configuration in which, as depicted in FIG. 7A, a portion of the air that enters through the manifolds 113 flows to the opposite side of the plate main body 110 through a channel groove 112a-1 formed on the first side of the plate main body 110, through a via hole 112a-2, and finally through another channel groove 112a-3 formed on the opposite side of the plate main body 110. Air that has passed through the reaction flow channel 111 leaves through the manifolds 113 after the air passes in a reverse order through another first type channel 112a. The first type channel 112a through which the air exits is of the same shape as the first type channel 112a through which the air enters. The first type channels 112a are connected to each other via the reaction flow channels 111 and are configured in this embodiment across the bipolar plates 100, the first pattern bipolar plate 100-1, and the second pattern bipolar plate 100-2 in a diagonal direction.

The first type channels 112a are also connected to the manifolds 113. The manifolds 113 and the reaction flow channels 111 are continuously connected through the first type channels 112a, which extend to each of the first side and the opposite side of the plate main body 110. Generally, about half of each of the first type channels 112a is on each side of the plate main body 110 connected by the via hole 112a-2. For example, if the channel groove 112a-1 is on the first side of the plate main body 110, then the 112a-3 is on the opposite side of plate main body 110. The formation of the first type channel 112a results in flat surfaces F formed on each the first side and the opposite side of the plate main body 110 without any channel grooves, and the gasket 300 is attached to the flat surface F. The flat surfaces F allow for the gasket 300 to form a continuous seal about the perimeter of the plate main body 110.

On the other hand, the second type channels 112b are flow channels through which hydrogen gas passes. The second type channels 112b have configurations in which, as depicted in FIG. 7B, hydrogen gas that enters the second type channel 112b from the manifold 113 first flows to the opposite side of the plate main body 110 and into a channel groove 112b-1. The hydrogen enters the channel groove 112b-1 and flows through a via hole 112b-2 to a channel groove 112b-3 formed on the first side of the plate main body 110. The channel groove 112b-1 is formed on the opposite side of the plate main body 110 from where the hydrogen enters the manifold 113. The channel groove 112b-3 is back on the first side of the plate main body 110—the same side as the side in which the hydrogen enters the manifold 113. The channel groove 112b-1 and the channel groove 112b-3 are on opposite sides of the plate main body 110 and are connected by a via hole 112b-2, extending from the opposite side of the plate main body 110 to the first side of the plate main body 110. After passing through the channel groove 112b-1, the via hole 112b-2, and the channel groove 112b-3, the hydrogen is then supplied to the reaction flow channel 111. While the hydrogen flows through the reaction flow channel 111, electrons are stripped from the hydrogen by the anode (not shown) and the resulting positively charged hydrogen atoms migrate across the MEA (not shown) to join oxygen and reform water. The hydrogen gas that has passed through the reaction flow channel 111 and not reacted, like the air, leaves the manifold 113 after the hydrogen gas passes in a reverse order through another second type channel 112b to a manifold 113. The two second type channels 112b, in this embodiment, are connected to each other via the reaction flow channels 111 and arranged across the bipolar plates 100, the first pattern bipolar plate 100-1, and the second pattern bipolar plate 100-2 in a diagonal direction. Generally, about half of each second type channel 112b is on each of the first side and the second side of the plate main body 110 and the two halves are connected to each other by a via hole 112a-2. The formation of the second type channel 112b results in flat surfaces F formed on each the first side and the opposite side of the plate main body 110 having no channel grooves. The flat surfaces F allow for the gasket 300 to form a continuous seal about the perimeter of the plate main body 110.

In other words, the first and second type channels 112a and 112b, which are connection channels 112, are formed to supply fuel to the reaction flow channels 111 and accommodate a continuous flat surface F formed around the reaction flow channels 111. The gasket 300 is attached to the flat surface F so that the fuel flow from the manifolds 113 to the connection channels 112 to the reaction flow channels 111 is not affected by the gasket 300.

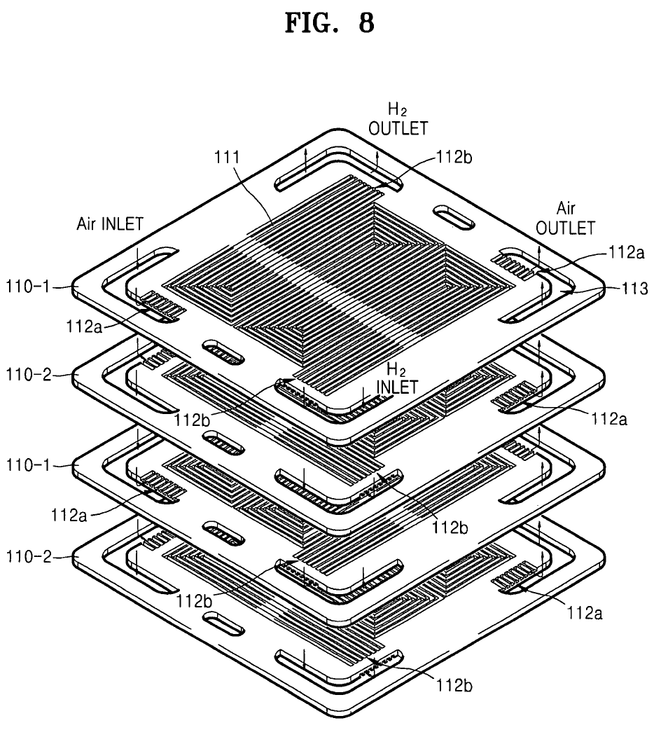

Referring to FIG. 8, the structure of the first pattern bipolar plate 100-1 and the second pattern bipolar plate 100-2 is shown as if the first pattern bipolar plate 100-1 and the second pattern bipolar plate 100-2 were disposed in a fuel cell stack. The MEA 200 and the gasket 300 are omitted so the flow of fluid between the first and second pattern bipolar plates 100-1 and 100-2, respectively, can be clearly seen. Air, which is an oxygen source, enters through a manifold 113 corresponding to an Air INLET. A portion of the entering air flows through the corresponding reaction flow channel 111 via the first type channel 112a. A portion of the air that enters the manifold 113 enters the first type channel 112a then travels to the opposite side of the first pattern bipolar plate 100-1 to the reaction flow channel 111. Oxygen in the air reacts at the MEA 200, and the air exits the reaction flow channel 111 into the first type channel 112a. In the first type channel 112a, the air travels back to the first side of the first pattern bipolar plate 100-1 and into the manifold 113 corresponding with the Air OUTLET, joining air exiting from other reaction flow channels 111 and first type channels 112a. Another portion of the air that entered the Air INLET continues on to react with the MEA 200 through the reaction flow channels 111 of next plate—the second pattern bipolar plate 100-2. The portion of air enters another first type channel 112a in the same manner as previously described, but the first type channel 112a is located in another location of the manifold 113. Such different location of the first type channel 112a prevents the gasket 300 (not shown) from blocking flow of the air from the manifold 113 to the reaction flow channels 111 when several gaskets 300 are stacked in a fuel cell structure. The air flows through reaction flow channels 111 and exits into another first type channel 112a as described above. Again, the first type channel 112a through which the air exits is located in a different location of the manifold 113 from the location of the first type channel 112a through which the air exits from the adjacent first pattern bipolar plates 100-1. Again, the different location of the first type channel 112a, as compared to the location of the first type channel 112a of the adjacent first pattern bipolar plates 100-1 in the manifold 113, provides for flat surfaces F to which the gaskets 300 attach.

Hydrogen also enters through a manifold 113 corresponding to an H2 INLET A portion of the hydrogen flows to the opposite side of the first pattern bipolar plate 100-1 before entering the second type channel 112b. Within the second type channel 112b, the hydrogen flows back to the first side of the first pattern bipolar plate 100-1 to the reaction flow channels 111. The hydrogen reacts with the MEA 200 (not shown) while flowing through the reaction flow channels 111. The unused hydrogen then exits the reaction flow channels 111 through another second type channel 112b. Again, in the second type channel 112b, the hydrogen flows back to the opposite side of the first pattern bipolar plate 100-1 before entering the manifold 113 associated with the H2 OUTLET to join other unused hydrogen and exit the fuel cell stack. Another portion of hydrogen flows past, as depicted in FIG. 8, the first pattern bipolar plate 100-1 to enter the reaction flow channels of the second pattern bipolar plate 100-2 through another second type channel 112b. However, the second type channel 112b is located in a different position of the manifold 113 in the second pattern bipolar plate 100-2 than the second type channel 112b in the first pattern bipolar plate 100-1. The location change of the connection channels 112 between the first pattern bipolar plate 100-1 and the second pattern bipolar plate 100-2 prevents the gasket 300 from entering the connection channels 112 due to misalignment. As such, the gasket 300 is prevented from inhibiting fluid flow to the reaction flow channels 111. Also, the location change of the connection channels 112 between the first and second pattern bipolar plates 100-1 and 100-2 results in the connection channels 112 crossing each other to enter or to exit the manifolds 113f.

Thus, a bipolar plate that ensures continuous flow of gasses through flow channels and a stack of the bipolar plates can be realized.

A bipolar plate according to an embodiment of the present invention and a stack having the bipolar plate has, among others, the following advantages.

A very stable sealing state can be maintained since a gasket is attached to a flat surface of a plate main body. In particular, the risk of flow channels being blocked is decreased since connection channels are configured such that a gasket is not disposed between two receiving spaces that are facing each other.

The number of parts and assembly work can be reduced since additional parts such as the conventional bridge plate are not necessary.

The volume of the receiving areas is increased with respect to the related art as no bridge plate is necessary to block the gasket from entering the receiving areas.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A bipolar plate comprising:
a plate main body having a surface and an opposite surface, each surface having reaction flow channels through which fluids pass;
manifolds formed on the plate main body in the form of an inlet to introduce a fluid to the reaction flow channels and an outlet to discharge the fluid from the reaction flow channels; and
connection channels that are formed on the plate main body to connect the reaction flow channels and the manifolds, and to which gaskets for sealing the bipolar plates are attached when the bipolar plates are stacked,
wherein the connection channels are formed such that flat regions of both the surface and the opposite surface of the plate main body face each other when the plate main bodies are stacked, and the gaskets are attached to the flat surfaces of the plate main bodies.

2. The bipolar plate of claim 1, wherein the connection channel comprises a first channel, which is connected to a manifold on the surface of the plate main body and connected through the plate main body to the reaction flow channel formed on the opposite surface of the plate main body, and a second channel connected to a manifold on the opposite surface of the plate main body and connected through the plate main body to the reaction flow channel on the surface of the plate main body,
wherein, when the plate main bodies are stacked, the first channels are aligned to be stacked on the first channels, and the second channels are aligned to be stacked on the second channels, but the first channels and the second channels of adjacent plate main bodies do not overlap each other.

3. The bipolar plate of claim 2, wherein the first channels and the second channels of adjacent plate main bodies cross each other.

4. The bipolar plate of claim 1, wherein the flat surfaces are formed on edge portions of the plate main bodies that face each other when the plate main bodies are stacked so that the gasket is attachable to the edge portions of the plate main bodies together with the flat surfaces formed by the connection channels.

5. The bipolar plate of claim 1, wherein the manifolds have an L shape or an I shape through which fluids including hydrogen and oxygen can flow, and the manifolds and the reaction flow channels are connected by the connection channels.

6. A fuel cell having a stack in which assemblies of two electrodes, an electrolyte membrane and bipolar plates are stacked,
wherein the bipolar plates comprise:
a plate main body having a surface and an opposite surface, each surface having reaction flow channels through which fluids pass;
manifolds formed on the plate main body in the form of an inlet for introducing a fluid to the reaction flow channels and an outlet to discharge the fluid from the reaction flow channels; and
connection channels that are formed on the plate main body to connect the reaction flow channels and the manifolds, and to which gaskets for sealing the bipolar plates are attached when the bipolar plates are stacked,
wherein the connection channels are formed such that flat regions of both the surface and the opposite surface of the plate main body face each other when the plate main bodies are stacked, and the gaskets are attached to the flat surfaces of the plate main bodies.

7. The fuel cell of claim 6, wherein the connection channels comprise:
a first channel, which is connected to a manifold on the surface of the plate main body and connected through the plate main body to the reaction flow channel formed on the opposite surface of the plate main body; and
a second channel connected to a manifold on the opposite surface of the plate main body and connected through the plate main body to the reaction flow channel on the surface of the plate main body,
wherein, when the plate main bodies are stacked, the first channels are aligned to be stacked on the first channels, and the second channels are aligned to be stacked on the second channels, but the first channels and the second channels of adjacent plate main bodies do not overlap each other.

8. The fuel cell of claim 7, wherein the first channels and the second channels of adjacent plate main bodies cross each other.

9. The fuel cell of claim 6, wherein the flat surfaces are formed on edge portions of the plate main bodies that face each other when the plate main bodies are stacked so that the gasket can be attached to the edge portions of the plate main bodies together with the flat surfaces formed by the connection channels.

10. A bipolar plate, comprising:
a plate main body having a first side and an opposite side;
reaction flow channels on both the first side and the opposite side;
manifolds to supply fluids to and remove fluids from the reaction flow channels;
first connection channels to connect the manifolds to the reaction flow channels on the first side; and
second connection channels to connect the manifolds to the reaction flow channels on the opposite side,
wherein the first connection channels connect to the manifolds on the opposite side of the plate main body and extend therethrough to connect to the reaction flow channels on the first side of the plate main body, and
the second connection channels connect to the manifolds on the first side of the plate main body and extend therethrough to connect to the reaction flow channels on the opposite side of the plate main body.

11. The bipolar plate of claim 10, wherein the first connection channels form first flat surfaces on the first side of the plate main body, and
the second connection channels form second flat surfaces on the opposite side of the plate main body,
wherein
the first and second flat surfaces allow for a gasket to circumscribe an area in which the reaction flow channels are formed, and the gasket does not separate two connection channels on adjacent stacked bipolar plates.

12. The bipolar plate of claim 10, wherein the first connection channels align with the first connection channels of adjacent plate main bodies, and the second connection channels align with the second connection channels of adjacent plate main bodies when at least two bipolar plates are stacked.

13. The bipolar plate of claim 12, wherein the first connection channels of adjacent plate main bodies do not overlap, and the second connection channels of adjacent plate main bodies do not overlap.

14. The bipolar plate of claim 12, wherein the first connection channels of adjacent plate main bodies cross, and the second connection channels of adjacent plate main bodies cross.

15. Complementary bipolar plates, comprising:
a first bipolar plate and a second bipolar plate, each comprising:
a plate main body having a first side and an opposite side;
reaction flow channels on both the first side and the opposite side;
manifolds to supply fluids to and remove fluids from the reaction flow channels;
first connection channels to connect the manifolds to the reaction flow channels on the first side; and
second connection channels to connect the manifolds to the reaction flow channels on the opposite side,
wherein the first connection channels connect to the manifolds on the opposite side of the plate main body and extend therethrough to connect to the reaction flow channels on the first side of the plate main body, and
the second connection channels connect to the manifolds on the first side of the plate main body and extend therethrough to connect to the reaction flow channels on the opposite side of the plate main body,
wherein the first, the second, the third, and the fourth manifolds of each of the first bipolar plate and the second bipolar plate align, and
the first connection channels of the first bipolar plate are in a first area of first and second manifolds and the first connection channels of the second bipolar plate are in a second area of the first and the second manifolds and,
the second connection channels of the first bipolar plate are in a first area of third and fourth manifolds and the first connection channels of the second bipolar plate are in a second area of the third and the fourth manifolds.

16. The complementary bipolar plates of claim 15, wherein the first bipolar plate has a first flat surface that circumscribes an area in which the reaction flow channels of the first bipolar plate are formed, and the second bipolar plate has a second flat surface that circumscribes an area in which the reaction flow channels of the second bipolar plate are formed, wherein the first flat area and the second flat area correspond to each other.

17. A fuel cell stack, comprising:
a plurality of membrane and electrode assemblies;
a plurality of bipolar plates, comprising:
a plate main body having a first side and an opposite side;
reaction flow channels on both the first side and the opposite side;
manifolds to supply fluids to and remove fluids from the reaction flow channels;
first connection channels to connect the manifolds to the reaction flow channels on the first side; and
second connection channels to connect the manifolds to the reaction flow channels on the opposite side,
the first connection channels connect to the manifolds on the opposite side of the plate main body and extend therethrough to connect to the reaction flow channels on the first side of the plate main body, and
the second connection channels connect to the manifolds on the first side of the plate main body and extend therethrough to connect to the reaction flow channels on the opposite side of the plate main body
wherein the plurality of membrane and electrode assemblies are alternately stacked with the plurality of bipolar plates.

18. The fuel cell stack of claim 17, further comprising a gasket that seals the alternating membrane and electrode assemblies and bipolar plates and that circumscribes an area in which the reaction flow channels are formed, and the gasket does not separate the first or the second connection channels of the first bipolar plate from the first or the second connection channels of the adjacent bipolar plates.

19. The fuel cell stack of claim 17, wherein the bipolar plates are stacked so that the first and second connection channels do not face each other.

20. A fuel cell stack, comprising:
alternately stacked first bipolar plates and second bipolar plates, each first and second bipolar plate comprising:
a plate main body having a first side and an opposite side;
reaction flow channels on both the first side and the opposite side;
manifolds to supply fluids to and remove fluids from the reaction flow channels;
first connection channels to connect the manifolds to the reaction flow channels on the first side; and
second connection channels to connect the manifolds to the reaction flow channels on the opposite side,
wherein the first connection channels connect to the manifolds on the opposite side of the plate main body and extend therethrough to connect to the reaction flow channels on the first side of the plate main body, and
the second connection channels connect to the manifolds on the first side of the plate main body and extend therethrough to connect to the reaction flow channels on the opposite side of the plate main body,
wherein the first, the second, the third, and the fourth manifolds of each of the first bipolar plate and the second bipolar plate align, and
the first connection channels of the first bipolar plate are in a first area of first and second manifolds and the first connection channels of the second bipolar plate are in a second area of the first and the second manifolds and,
the second connection channels of the first bipolar plate are in a first area of third and fourth manifolds and the first connection channels of the second bipolar plate are in a second area of the third and the fourth manifolds, and
a plurality of membrane and electrode assemblies disposed between the alternately stacked first and second bipolar plates.

21. The fuel cell stack of claim 20, further comprising a gasket that seals the alternating membrane and electrode assemblies and complementary bipolar plates and that circumscribes an area in which the reaction flow channels are formed, and the gasket does not separate the first or the second connection channels of one complementary bipolar plate from the first or the second connection channels of the adjacent complementary bipolar plates.
